(19) United States
(12) Patent Application Publication
(10) Pub. No.: US 2024/0070291 A1
(43) Pub. Date: Feb. 29, 2024

(54) ATTACK PATH ANALYSIS APPARATUS FOR VEHICLE CYBER SECURITY AND ATTACK PATH ANALYSIS METHOD THEREOF

(71) Applicants: Hyundai Motor Company, Seoul (KR); Kia Corporation, Seoul (KR)

(72) Inventor: KWON HYEONG LEE, Ansan-si (KR)

(21) Appl. No.: 18/181,693

(22) Filed: Mar. 10, 2023

(30) Foreign Application Priority Data
Aug. 24, 2022 (KR) 1020220106481

(51) Int. Cl. G06F 21/56

(52) U.S. Cl. CPC G06F 21/566; G06F 21/567; G06F 2221/034

(57) ABSTRACT

An attack path analysis apparatus for cyber security of a vehicle includes a database that stores information on threat scenarios of damage scenarios occurring in the vehicle and information on an attack path for each of the threat scenarios, and a processor that interworks with the database to search for and output the attack path for each threat scenario for the damage scenarios for which threat analysis is requested when the threat analysis for specific damage scenarios is requested through a user interface device.

### CROSS-REFERENCE TO RELATED APPLICATION

This application claims the benefit of priority to Korean Patent Application No. 10-2022-0106481, filed in the Korean Intellectual Property Office on Aug. 24, 2022, the entire contents of which are incorporated herein by reference.

### TECHNICAL FIELD

The present disclosure relates to cyber security of a vehicle, and more particularly, to a technology capable of more efficiently performing attack path (or attack feasibility) analysis for threats that may occur in a vehicle.

### BACKGROUND

Today, vehicles have evolved into connected cars and autonomous vehicles, and software has been also changed in complexity to control advanced vehicle functions. As software complexity increases, vulnerabilities inherent in software increase, and cyber threats such as hacking to exploit them have been also rapidly increased. Therefore, cyber security has become a very important factor in vehicle design.

The international vehicle cybersecurity standard (UNR No. 155) adopted by the automotive international standards council (WP.29) under European Economic Council (UNECE) stipulates the requirements that automobile manufacturers must comply with to ensure vehicle cybersecurity. Such requirements are broadly classified into two categories. The first is the requirement for a cyber security management system that must be established at the enterprise level, and the second is the requirement for the type of vehicle that is subject to type approval. Automakers must establish a cyber security management system to obtain the type approval, and document the results of risk assessment and security testing for each type of vehicle to submit to type approval authorities or technical services.

ISO/SAE 21434 is a vehicle cybersecurity standard that defines procedures and organizational requirements for achieving strong vehicle cybersecurity. In the ISO/SAE 21434 standard, when threat analysis and risk assessment (TARA) is performed as a threat analysis and risk assessment scheme, the minimum requirements may be present for each activity and examples of a headlamp system. As such, in vehicle development, it is necessary to perform threat analysis in consideration of all possible threats in a vehicle.

### SUMMARY

The present disclosure has been made to solve the above-mentioned problems occurring in the prior art while advantages achieved by the prior art are maintained intact.

An aspect of the present disclosure provides an analysis apparatus and analysis method capable of more efficiently performing attack path analysis for threats that may occur in a vehicle, and capable of performing attack path analysis of threats for each in-vehicle control system.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an attack path analysis apparatus for cyber security of a vehicle includes a database that stores information regarding one or more threat patterns of damage scenarios occurring in the vehicle and information on an attack path for the respective threat patterns, and a processor that interworks with the database to search for and output the attack path for respective threat patterns for the damage scenarios for which threat analysis is requested when the threat analysis for specific damage scenarios is requested through a user interface device.

Preferably, the database may store information on a threat pattern derived for respective damage scenarios and a threat list in which attack paths are defined for respective threat types (spoofing, tampering, repudiation, information disclosure, denial of service, elevation of privileges: STRIDE) of an asset type.

Preferably, the database may store the threat patterns derived for respective damage scenarios and asset-related information (function, asset, asset type, security property) and a threat type corresponding to the respective derived threat patterns.

Preferably, the processor may extract the threat patterns for respective damage scenario, extract an asset type and a threat type for respective extracted threat patterns, search for an attack path corresponding to the asset type and the threat type, and output the searched attack path in a preset format.

Preferably, the processor may extract information on an asset and a threat corresponding to respective threat patterns with respect to the damage scenarios for which the threat analysis is requested from a user among the damage scenarios, search for an attack path corresponding to the information on the asset and threat extracted by searching the threat list, and output information on the searched attack path in a preset document format.

Preferably, the processor may extract an asset type and a threat type corresponding to respective threat patterns.

Preferably, the threat list may include an attack path for respective threat types of the asset type and information on attack feasibility for the corresponding attack path.

Preferably, the processor may search for the information on the attack feasibility for the attack path together when searching for the attack path.

Preferably, the processor may output previously registered damage scenarios on a screen to allow the user to select desired damage scenarios.

Preferably, the processor may output a preset blank form to allow the user to define and describe the corresponding attack path when the attack path is not found.

Preferably, the processor may determine whether a threat pattern to be further analyzed remains when the threat analysis of the corresponding threat pattern is completed.

According to an aspect of the present disclosure, an attack path analysis method for cyber security of a vehicle includes extracting, by an attack path analysis apparatus for vehicle cyber security, information on an asset and a threat corresponding to threat patterns of damage scenarios when a user requests analysis of the damage scenarios, wherein the attack path analysis apparatus stores information regarding the threat patterns derived based on respective damage scenarios with respect to the damage scenarios occurring in the vehicle and information on an attack path for respective threat patterns in a database, searching for information on the attack path for respective threat patterns and determining whether an attack path corresponding to the information on the asset and the threat exists, and outputting information on the searched attack path in a preset format when the attack path exists.

Preferably, the information on the threat patterns derived based on respective damage scenarios may include the threat patterns derived for respective damage scenarios and asset-related information and a threat type corresponding to the respective derived threat patterns.

Preferably, the extracting of the information on the asset and the threat may include extracting an asset type and a threat type corresponding to respective threat patterns.

Preferably, the extracting of the information on the asset and the threat may include extracting an asset type and a threat type corresponding to respective threat patterns for the respective derived threat patterns.

Preferably, the information on the attack path for respective threat patterns may include information stored by matching an asset type and a threat type for respective threat patterns with the attack path.

Preferably, the determining of whether the attack path exists may include determining whether an attack path matched with the asset type and threat type exists.

Preferably, the determining of whether the attack path exists may include searching for information on attack feasibility for the corresponding attack path.

Preferably, the attack path analysis method may further include outputting previously registered damage scenarios on a screen to receive a request from the user for damage for which analysis is desired.

Preferably, the attack path analysis method may further include outputting a preset blank form to allow the user to define and describe the corresponding attack path when the attack path does not exist.

### BRIEF DESCRIPTION OF THE DRAWINGS

FIG. 1 is a block diagram schematically illustrating an example of an attack path analysis apparatus for cyber security of a vehicle.

FIG. 2 is a diagram illustrating an example of asset-related information identified for each damage scenario that may occur in a vehicle, a threat type, and a threat scenario derived based on such information.

FIG. 3 is a diagram illustrating an example of a threat list stored in the database of FIG. 1.

FIG. 4 is a diagram illustrating an example of contents of the attack paths and the attack feasibility for each attack path defined in the threat list of FIG. 3.

FIG. 5 is a flowchart illustrating an exemplary attack path analysis method.

### DETAILED DESCRIPTION

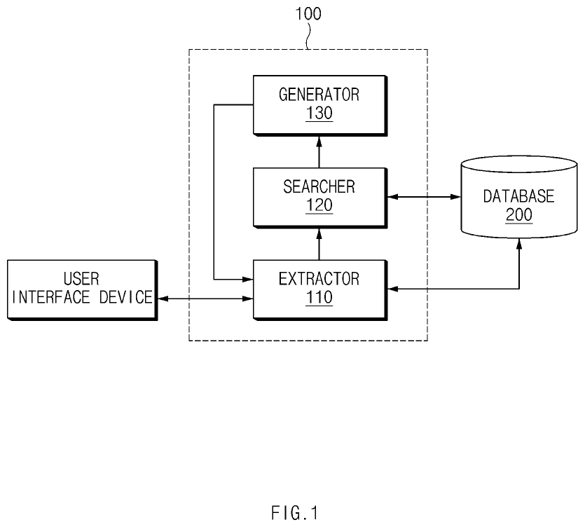

FIG. 1 is a block diagram schematically illustrating an example of an attack path analysis apparatus for cyber security of a vehicle.

Referring to FIG. 1, an attack path analysis apparatus for cyber security of a vehicle may include an analysis processor 100 and a database 200.

The analysis processor 100 searches the database 200 for attack paths for damage scenarios that may occur in a vehicle and attack feasibility for the corresponding attack path, and then, may document and output the information in a predefined form.

For example, when a user (vehicle designer) selects damage scenarios to be analyzed through a user interface device, after finding an attack path for a corresponding damage scenario and attack feasibility for a corresponding attack path by threat scenarios by using data stored in the database 200, the analysis processor 100 may process the corresponding information in a preset document format and provide it to the user.

The analysis processor 100 may include an extractor 110, a searcher 120, and a generator 130.

The extractor 110 may extract threat scenarios (threat patterns) for damage scenarios requested by the user from the data on the damage scenarios stored in the database 200 in advance, and may extract the asset type and the threat type for each extracted threat scenario and provide the asset type and the threat type to the searcher 120.

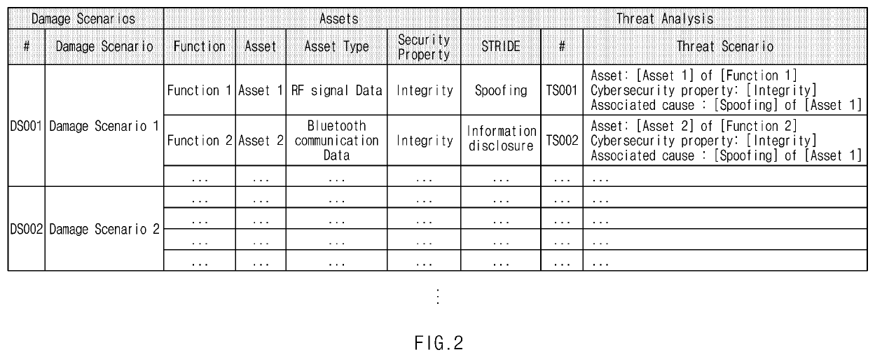

For example, FIG. 2 is a diagram illustrating an example of asset-related information identified for each damage scenario that may occur in a vehicle, a threat type, and a threat scenario derived based on such information.

The user may identify a function, an asset, an asset type, a security property and STRIDE for each damage scenario for all possible damage scenarios that may occur in the vehicle, derive threat scenarios in advance based on it, and database the corresponding information as shown in FIG. 2. The asset may include anything that can harm stakeholders due to the damage of cybersecurity properties representing confidentiality, integrity and availability. In this case, because the stakeholder includes any individual or organization that is harmed by a cybersecurity threat, the stakeholder may include automakers, contractors, and vehicle owners. The data of FIG. 2 may be stored in the database 200.

A user may selectively provide data on damage scenarios for which threat analysis is desired among the damage scenarios that are databased as shown in FIG. 2 to the extractor 110. For example, when a threat analysis request is received from a user through a user interface device (e.g., a keyboard), the extractor 110 may access the database 200 and read information on damage scenarios stored in the database 200. In addition, the extractor 110 may display all of the previously registered damage scenarios (a list of damage scenarios) on the user interface device 10 (e.g., a monitor screen) to allow the user to select the damage scenarios that the user desires to analyze the threat.

When the user selects desired damage scenarios by using the user interface device, the extractor 110 may extract threat scenarios for each selected damage scenario, and after extracting information on the asset type and threat type (one of spoofing, tampering, repudiation, information disclosure, denial of service, and elevation of privileges) for each of the extracted threat scenarios, may sequentially provide the information on each threat scenario to the searcher 120. In this case, when information (asset type and threat type) on a specific threat scenario is transmitted to the searcher 120 and a signal is received from the generator 130 indicating that the analysis of the threat scenario has been completed, the extractor 110 may transmit information on the next threat scenario to the searcher 120.

When the information about the asset type and threat type (STRIDE) is received from the extractor 110, the searcher 120 may search for a list of threats pre-stored in the database 200 to search for the attack path corresponding to the asset type and threat type, and the attack feasibility for the corresponding attack path.

When the attack path and attack feasibility corresponding to the asset type and threat type provided from the extractor 110 are already defined in the threat list, the searcher 120 may read the corresponding information (information on the attack path and the attack feasibility) and provide the corresponding information to the generator 130. When the attack path and attack feasibility corresponding to the asset type and threat type provided from the extractor 110 have not yet been defined, the searcher 120 may generate a signal informing that there is no information and provide the signal to the generator 130.

When information on the attack path and attack feasibility of a specific threat scenario is received from the searcher 120, the generator 130 may generate and output a document (e.g., a report) based on the received information in a predefined format. When a signal indicating that there is no information is received from the searcher 120, the generator 130 may output a predefined blank form in which no content is written. After generating and outputting the documents in a preset form or generate and output a blank document form, the generator 130 may generate a signal indicating that the analysis of the corresponding threat scenario is completed and transmit the signal to the extractor 110.

The database 200 may store the information on the threat scenarios derived based on each damage scenario for the damage scenarios that may occur in a vehicle, and a threat list in which the attack path and attack feasibility are predefined for each threat type of the asset type.

For example, as shown in FIG. 2, the database 200 may store asset-related information (function, asset, asset type, security property, and the like) corresponding to each of the threat scenarios derived for each damage scenario and the derived threat scenarios and information on the threat type (STRIDE).

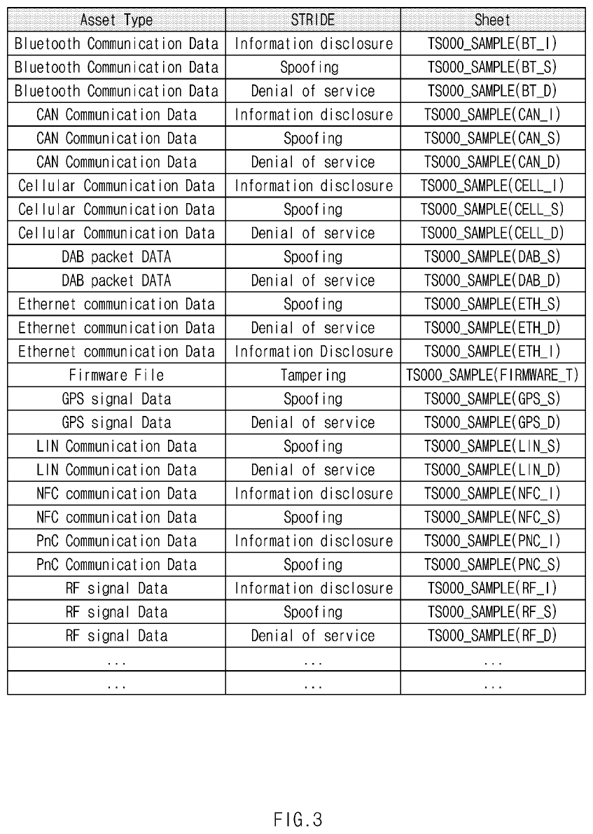

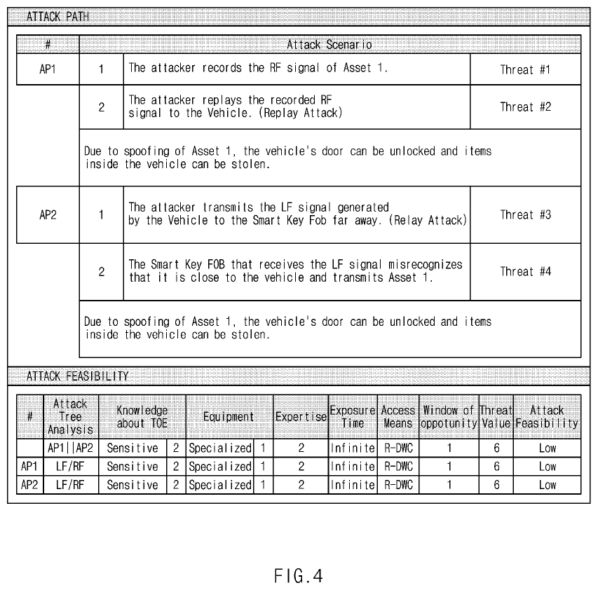

FIG. 3 is a diagram illustrating an example of a threat list stored in the database of FIG. 1. FIG. 4 is a diagram illustrating an example of contents of the attack paths and the attack feasibility for each attack path defined in the threat list of FIG. 3. The threat list may be configured by the asset type and threat type of FIG. 2 as shown in FIG. 3 and databased in the database 200. In the threat list of FIG. 3, each sheet may include information on at least one attack path defined as in FIG. 4 and the attack feasibility of the attack path defined as shown in FIG. 4 by taking into consideration all possible threats in the vehicle for each threat type of the corresponding asset type.

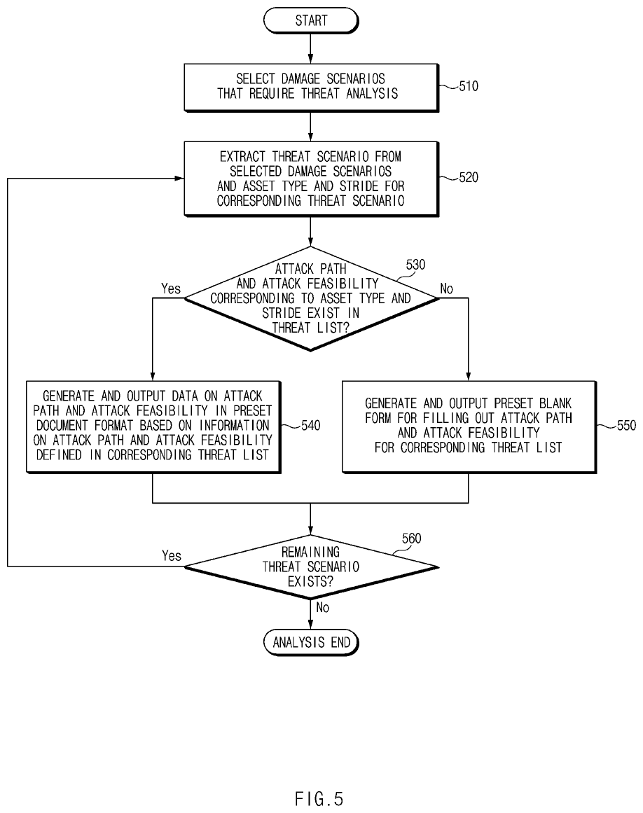

FIG. 5 is a flowchart illustrating an exemplary attack path analysis method.

First, as shown in FIG. 2, the user may identify the corresponding function, asset, asset type, security property and STRIDE for the damage scenarios that may occur in relation to the vehicle, and may derive a threat scenario based on the identified information.

As described above, the information identified and derived for the damage scenarios may be databased to be stored in advance in the database 200. As described above, identification and matching of the asset-related information (function, asset, asset Type, security property and the like) and the threat type (STRIDE) based on each damage scenario is possible by using the existing cyber security management system (CSMS), threat analysis and risk assessment (TARA), and threat modeling tool, and the like.

When a threat analysis request is received from the user through the user interface device, in S510, the extractor 110 may read information about the damage scenarios stored in the database 200 and display the previously registered damage scenarios on the screen, such that the user selects damage scenarios for which threat analysis is desired.

For example, control systems installed in a corresponding vehicle may be different depending on the kind or type of vehicle to be produced. Depending on the type of the control system, damage scenarios that may occur in the corresponding control system may also be different from each other. In addition, as the functions of the vehicle are diversified and advanced, more control systems have been applied to a vehicle. Accordingly, there are many cases in which a vehicle designer (user) is required to analyze an attack path for threats that may occur for each type of vehicle or for each control system.

To this end, in some implementations, the extractor 110 may display all of the damage scenarios previously registered in the database 200 on the screen to allow the user to select desired damage scenarios (e.g., the damage scenarios for a desired control system) from among the damage scenarios displayed on the screen. Thus, the user may analyze the attack path and attack feasibility for each of all possible threat scenarios for each control system of a vehicle.

When the user's selection is complete, in S520, the extractor 110 may extract the asset type and threat type (STRIDE) corresponding to the first threat scenario (e.g., the threat scenario of TS001) of the first damage scenario (e.g., the damage scenario of DS001 in FIG. 2) among the damage scenarios selected by the user, and provide the asset type and threat type to the searcher 120.

According to the threat type (STRIDE) classification, it is possible to classify threats corresponding to each of the six goals by adding three elements of authentication, non-repudiation and authorization to three security elements of confidentiality, integrity and availability.

In this case, spoofing, which is related to authentication among security attributes, may identify threats to obtain system privileges using a false account or the like.

Tampering, which is related to integrity among security attributes, may identify threats that illegally change data.

Repudiation, which is related to non-repudiation among security attributes, may identify threats that deny that a specific service has not been performed or that it is not responsible.

Information disclosure, which is related to confidentiality among security attributes, may identify threats that provide information to someone who does not have access rights.

Denial of Service, which is related to availability among security attributes, may identify threats that prevent a service or application from being performed normally.

Elevation of privileges, which is related to authorization among security attributes, may identify a threat that allows someone to perform an unauthorized service by receiving authorization.

When the searcher 120 receives information on the asset type and threat type from the extractor 110, in S530, the searcher 120 may search for the threat list stored in the database 200 in order to determine whether the attack path and attack feasibility corresponding to the asset type and threat type are defined.

The searcher 120 may provide the search result to the generator 130. For example, when the attack path and attack feasibility for the corresponding threat scenario are already defined and stored in the threat list, the searcher 120 may read the corresponding information from the database 200 and provide the corresponding information to the generator 130. To the contrary, when the attack path and attack feasibility for the corresponding threat scenario have not yet been defined (when not stored in the threat list), the searcher 120 may generate a signal indicating that there is no corresponding information and provide the signal to the generator 130.

When the information on the attack path and attack feasibility of the corresponding threat list is received from the searcher 120 in S530, in S540, the generator 130 may generate and output data on the attack path and attack feasibility in a preset document format based on the information on the received attack path and attack feasibility information.

Automobile manufacturers must establish a cyber security management system to obtain type approval, identify major components by vehicle type, and submit, to type approval authorities or technical services, the documented results of risk assessment and security testing according to the process specified in the cyber security management system. Accordingly, the generator 130 may generate and output data on the corresponding attack path and attack feasibility in accordance with the document format to be submitted to type approval authorities or technical services.

To the contrary, when a signal indicating that there is no information about the attack path and attack feasibility is received, in S550, the generator 130 may generate and output a preset blank form to allow the user to define and describe the attack path and attack feasibility for the corresponding threat list.

When step S540 or step S550 is completed, the generator 130 may generate a signal indicating that the analysis of the corresponding threat scenario is completed and transmit the signal to the extractor 110.

When the signal notifying that the analysis of the corresponding threat scenario is completed is received from the generator 130, in S560, the extractor 110 may determine whether a threat scenario to be further analyzed remains.

When the threat scenario to be analyzed remains, the extractor 110 may extract the information about the asset type and threat type for the next threat scenario (e.g., the threat scenario of TS002) from the database 200 and transmit the information to the searcher 120.

The operations of steps S520 to S550 described above may be repeatedly performed until the analysis of the threat scenarios of each damage scenario selected by the user is sequentially completed.

In some implementations, it is possible to more efficiently perform attack path analysis for threats that may occur in vehicles.

Furthermore, in some implementations, it is possible to perform attack path analysis by selectively classifying only threats that may occur in the corresponding control system for each in-vehicle control system.

What is claimed is:

1. An attack path analysis apparatus for cyber security of a vehicle, the attack path analysis apparatus comprising:
a database configured to store information regarding one or more threat patterns associated with one or more damage scenarios occurring in the vehicle and information regarding an attack path for the respective one or more threat patterns; and
a processor operably connected to the database and configured to, based on a threat analysis request for a specific damage scenario being received through a user interface device, search for and output the attack path for respective threat patterns for the one or more damage scenarios for which threat analysis is requested.

2. The attack path analysis apparatus of claim 1, wherein the database is configured to store information regarding a threat pattern derived for respective damage scenarios and a threat list in which one or more attack paths are defined for respective threat types of an asset type.

3. The attack path analysis apparatus of claim 1, wherein the database is configured to store (i) the one or more threat patterns derived for respective damage scenarios and (ii) asset-related information and a threat type corresponding to the respective derived threat patterns.

4. The attack path analysis apparatus of claim 1, wherein the processor is configured to:
extract the one or more threat patterns for respective damage scenarios,
extract an asset type and a threat type for the respective extracted one or more threat patterns,
search for an attack path corresponding to the asset type and the threat type, and
output the searched attack path in a preset format.

5. The attack path analysis apparatus of claim 2, wherein the processor is configured to:
extract information regarding an asset and a threat corresponding to respective threat patterns with respect to one or more damage scenarios for which the threat analysis request is received from the user interface device among the one or more damage scenarios,
search for an attack path corresponding to the extracted information regarding the asset and threat, and
output information regarding the searched attack path in a preset document format.

6. The attack path analysis apparatus of claim 5, wherein the processor is configured to:
extract an asset type and a threat type corresponding to the respective threat patterns.

7. The attack path analysis apparatus of claim 5, wherein the threat list includes an attack path for respective threat types of the asset type and information regarding a level of attack feasibility for the attack path.

8. The attack path analysis apparatus of claim 7, wherein the processor is configured to search the attack path and the information regarding the level of attack feasibility for the attack path simultaneously.

9. The attack path analysis apparatus of claim 5, wherein the processor is configured to output one or more previously registered damage scenarios on a display screen to receive one or more desired damage scenarios.

10. The attack path analysis apparatus of claim 5, wherein the processor is configured to, based on the attack path not being found, output a preset blank form through the user interface device to receive a description of the attack path.

11. The attack path analysis apparatus of claim 5, wherein the processor is configured to, based on the threat analysis of the threat pattern being completed, determine whether the threat pattern is to be further analyzed.

12. An attack path analysis method for cyber security of a vehicle, the attack path analysis method comprising:
extracting, based on a threat analysis request for a specific damage scenario being received, information regarding an asset and a threat corresponding to one or more threat patterns associated with one or more damage scenarios, by an attack path analysis apparatus for the cyber security of the vehicle, the attack path analysis apparatus being configured to store, in a database, (i) information regarding the one or more threat patterns derived based on respective damage scenarios with respect to the one or more damage scenarios occurring in the vehicle and (ii) information regarding an attack path for respective threat patterns;
searching for information regarding the attack path for respective threat patterns and determining whether an attack path corresponding to the information regarding the asset and the threat exists; and
outputting, based on the attack path being found, information regarding the searched attack path in a preset format.

13. The attack path analysis method of claim 12, wherein the information regarding the one or more threat patterns derived based on respective damage scenarios includes the one or more threat patterns derived for respective damage scenarios and asset-related information and a threat type corresponding to the respective one or more derived threat patterns.

14. The attack path analysis method of claim 13, wherein extracting the information regarding the asset and the threat includes:
extracting an asset type and a threat type corresponding to respective threat patterns.

15. The attack path analysis method of claim 13, wherein extracting the information regarding the asset and the threat includes:
extracting an asset type and a threat type corresponding to respective threat patterns for the respective one or more derived threat patterns.

16. The attack path analysis method of claim 12, wherein the information regarding the attack path for respective threat patterns includes information stored by matching an asset type and a threat type for respective threat patterns with the attack path.

17. The attack path analysis method of claim 16, wherein determining whether the attack path exists includes:
determining whether an attack path matched to the asset type and threat type exists.

18. The attack path analysis method of claim 12, wherein the determining of whether the attack path exists includes:
searching for information on regarding a level of attack feasibility for the attack path.

19. The attack path analysis method of claim 12, further comprising:
outputting one or more previously registered damage scenarios on a display screen to receive a request for one or more desired damage scenarios.

20. The attack path analysis method of claim 12, further comprising:
outputting, based on the attack path not being found, a preset blank form to receive a description of the attack path.
